(19) United States
(12) Patent Application Publication
(10) Pub. No.: US 2014/0138559 A1
(43) Pub. Date: May 22, 2014

(54) LAMPSHADE AND ILLUMINATION MODULE

(71) Applicants: Tzyy-Jang Tseng, Hsinchu (TW); Cheng-Yi Wang, Hsinchu (TW)

(72) Inventors: Tzyy-Jang Tseng, Hsinchu (TW); Cheng-Yi Wang, Hsinchu (TW)

(21) Appl. No.: 13/678,559

(22) Filed: Nov. 16, 2012

(51) Int. Cl. F21V 1/00; G21K 5/00

(52) U.S. Cl. CPC F21V 1/00; G21K 5/00
USPC 250/504 R; 362/351; 362/311.02

(57) ABSTRACT

A lampshade including a plurality of plate structures is provided. The plurality of plate structures are connected to one another to form a hollow casing having an opening. An illumination module including a base plate, a light source, and a lampshade is further provided. The light source is disposed on the base plate. The lampshade is covered on the base plate, and the light source is sited between the base plate and the lampshade. The lampshade includes a plurality of plate structures, wherein the plurality of plate structures are connected to one another to form a hollow casing having an opening.

### BACKGROUND OF THE INVENTION

1. Field of the Invention

The present invention generally relates to a lampshade and an illumination module.

2. Description of Related Art

A traditional illumination module mainly includes a light source and a lampshade covering the light source. The arrangement of the lampshade softens and uniformizes the light emitted by the light source so that people can look at the light without discomfort to the eyes.

A variety of light sources with different characteristics are available on the market so far. As an example, a light emitted diode (LED) light saves more electricity and the temperature on the surfaces of the light source is lower. However, due to the directivity of LED lights (i.e. the emitted light is focused on a certain direction), when LED lights are utilized for general illumination application, they have to be disposed in a proper way so that the light is able to be emitted to different directions for lightening up its surrounding area as possible.

In tradition, the lampshade will not change the shape of the emitted light in adapt to the environment and the usage needs. The shape of the lampshade is generally a fixed geometry for decoration purposes. A uniformity enhancement or characteristics change of the light through the design of the lampshade is one of the main topics of interest for the research and development people.

### SUMMARY OF THE INVENTION

Accordingly, the present invention is direct to a lampshade, wherein the combination of the lampshade and a light source provides light with uniformity and different color temperatures.

The present invention is direct to an illumination module using the above-mentioned lampshade.

The present invention provides a lampshade including a plurality of plate structures, wherein the plate structures are connected to one another to form a hollow casing having an opening.

In accordance with an embodiment of the lampshade of the present invention, the shape of the hollow casing is substantially dome-shaped, for example.

In accordance with an embodiment of the lampshade of the present invention, the lampshade further includes a plurality of phosphors scattered in the hollow casing.

In accordance with an embodiment of the lampshade of the present invention, the lampshade further includes a plurality of diffusion particles scattered in the hollow casing.

The present invention provides an illumination module including a base plate, a light source, and a lampshade. The light source is sited between the base plate and the lampshade, wherein the lampshade includes a plurality of plate structures, and wherein the plate structures are connected to one another to form a hollow casing having an opening.

In accordance with an embodiment of the illumination module of the present invention, the light source is, for example, a LED light, a fluorescent light, an ultraviolet light, or an X-ray light.

In accordance with an embodiment of the illumination module of the present invention, the LED light includes a chip on board (COB) LED light or a surface-mount technology (SMT) LED light.

In accordance with an embodiment of the illumination module of the present invention, the shape of the hollow casing is substantially dome-shaped, for example.

In accordance with an embodiment of the illumination module of the present invention, the lampshade includes a plurality of phosphors scattered in the hollow casing.

In accordance with an embodiment of the illumination module of the present invention, the lampshade includes a plurality of diffusion particles scattered in the hollow casing.

To sum up the above, the design of the lampshade and the illumination module of the present invention is a hollow casing formed by the plurality of plate structures which are connected to one another. Therefore, the light emitted from the light source disposed within the lampshade is able to emit to outside uniformly via the refraction or scattering by means of the plate structures of the lampshade. Additionally, when the phosphors or the diffusion particles are scattered within the lampshade, the characteristics of the light may be adjusted by the phosphors or the uniformity of the light may be enhanced by the diffusion particles in the lampshade and illumination module of the present invention.

In order to make the aforementioned and other objects, features and advantages of this invention comprehensible, a preferred embodiment accompanied with figures is described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a lampshade in accordance to an embodiment of the present invention.

FIG. 2 is a schematic view of a lampshade in accordance to another embodiment of the present invention.

FIG. 3 is a schematic view of an illumination module in accordance to an embodiment of the present invention.

FIG. 4 is a schematic view of another illumination module in accordance to another embodiment of the present invention.

### DESCRIPTION OF THE EMBODIMENTS

A lampshade and an illumination module of the present invention cause that the light emitted from a light source within the lampshade is able to be emitted out uniformly through a lampshade by the structure design of the lampshade. Such design prevents users' inconvenience from a narrow emission range that causes weak illumination on various directions. Thus, the lampshade and the illumination module of the present invention permit the light to lighten up the surrounding area for illumination enhancement.

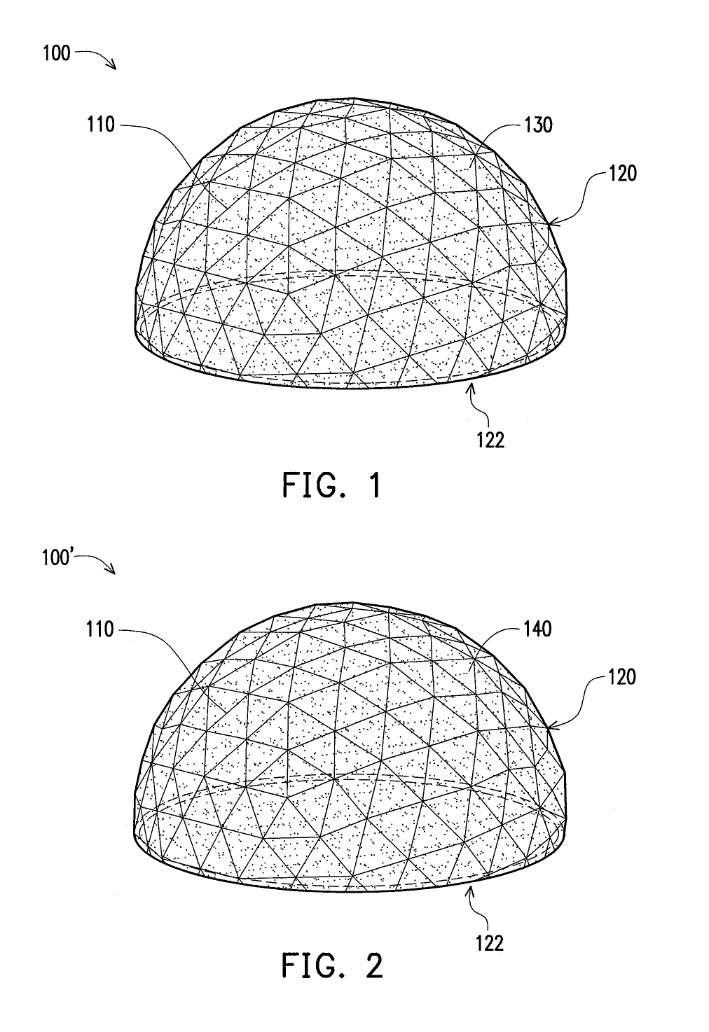

FIG. 1 is a schematic view of a lampshade in accordance to an embodiment of the present invention. Referring to FIG. 1, the lampshade 100 of the present invention includes a plurality of plate structures 110 connected to one another to form a hollow casing 120, wherein the hollow casing 120 includes an opening 122. The plate structure 110 is polygon-shaped. In the present embodiment, the plate structure 110 is triangular in shape, and yet in other embodiments, the plate structure 110 may be quadrilateral, pentagonal, hexagonal, or in other shapes. The hollow casing 120, for example, is in a polyhedron shape. For example, the shape of the hollow casing 120 may be substantially approximated to a hemi-spherical dome, but its contour is not a smooth hemisphere due to the plurality of plate structures 110 forming the hollow casing 120. Moreover, methods of forming the lampshade may be injection molding, spraying, covering, injection, punching, coating, and so on.

In the present embodiment, since the hollow casing 120 is formed by the plate structures 110, a light source (unillustrated) may be accommodated in the opening 122 of the hollow casing 120, and the light emitted from the light source emits to outside uniformly via the refraction or scattering by means of the plate structures 110 of the lampshade 100. Additionally, in other embodiments, the shape of the hollow casing 120 may be, but not limited to, a cone or a frustum.

Moreover, in the present embodiment, the lampshade 100 further includes a plurality of phosphors 130 scattered in the hollow casing 120. In terms of the hollow casing 120 scattered with the phosphors 130, a light source may be disposed therein, wherein the light source may be, for example, but not limited to, a light emitted diode (LED) light. Based on the needs and the requirements, a user is able to select different light sources for emitting different colors or color temperatures of light, wherein the characteristics of the emitted lights may be adjusted by the phosphors 130. For example, blue light may be excited to white light through the phosphors 130, and yet the characteristics adjustments are not limited to the above.

FIG. 2 is a schematic view of a lampshade in accordance to another embodiment of the present invention. Referring to FIG. 2, the difference between the lampshade 100′ in FIG. 2 and the lampshade 100 in FIG. 1 is mainly that the phosphors 130 are scattered in the hollow casing 120 of the lampshade in FIG. 1, while a plurality of diffusion particles 140 are scattered in a hollow casing 120′ of the lampshade 100′ in FIG. 2. In terms of the hollow casing 120′ scattered with the diffusion particles 140, a light source may be disposed therein, wherein the light source may be, for example, but not limited to, a fluorescent light. The light emitted from the light source scatters to different angles through the diffusion particles 140 in the hollow casing 120′ for a better uniformity in light emission.

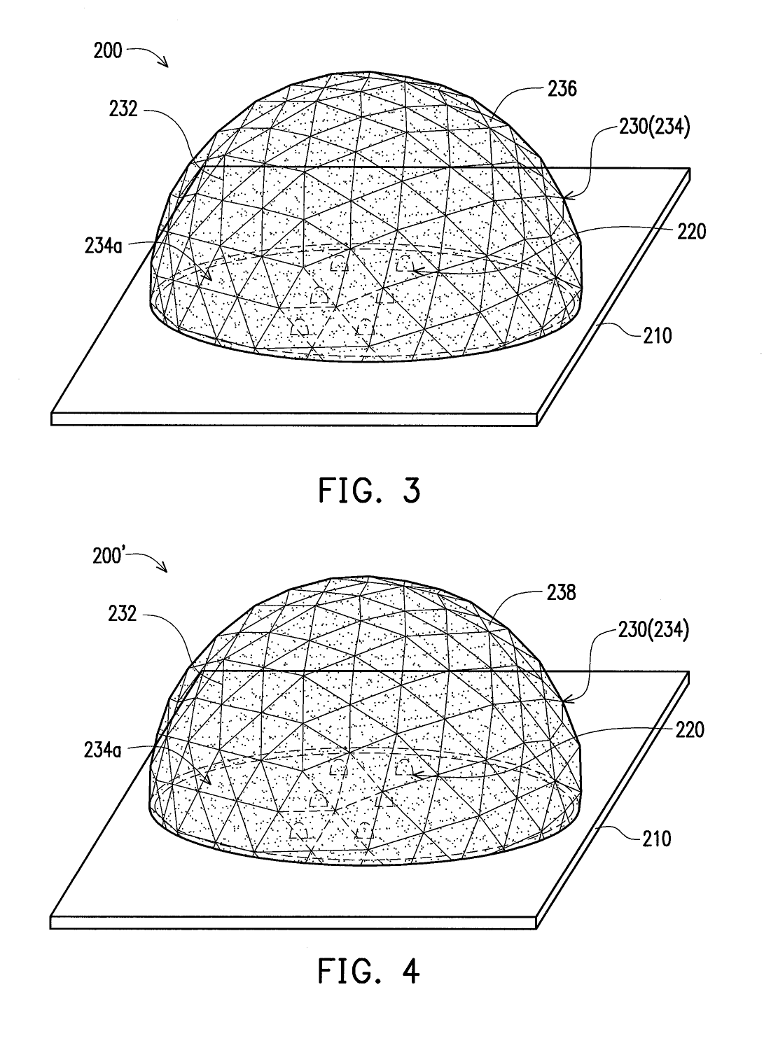

FIG. 3 is a schematic view of an illumination module in accordance to an embodiment of the present invention. Referring to FIG. 3, the illumination module 200 in the present embodiment includes a base plate 210, a light source 220, and a lampshade 230.

The light source 220 is disposed on the base plate 210. The light source may be, but not limit to, a LED light, a fluorescent light, an ultraviolet light, or an X-ray light. As an example, a LED light may be, but not limit to, a chip-on-board (COB) LED light or a surface-mount technology (SMT) LED light.

The lampshade 230 is disposed on the base plate 210, and the light source 220 is positioned between the base plate 210 and the lampshade 230. The lampshade 230 includes a plurality of plate structures 232, and the plate structures 232 connected to one another to form a hollow casing 234 having an opening 234a.

As shown in FIG. 3, the shape of the hollow casing 234 may be substantially approximated to a hemi-spherical dome, but its contour is not a smooth hemisphere due to the plurality of plate structures 232 forming the hollow casing 234. In other embodiments, the shape of the hollow casing 234 may certainly be, but not restricted to, a cone or a frustum.

In the present embodiment, the lampshade 230 is disposed on the base plate 210 so that the opening 234a of the hollow casing 234 is sealed by the base plate 210. The light source 220 positioned on the base plate 210 is covered between the base plate 210 and the lampshade 230. Moreover, the base plate 210 may be, for example, a printed circuit board. The light source 220 electrically connects to the base plate 210 for receiving electricity from the base plate 210. The hollow casing 234 is a transparent casing formed by the plurality of the plate structures 232. If the light source 220 is disposed within the hollow casing 234, the light emitted from the light source 220 emits to outside uniformly via the refraction by means of the plate structures 232 of the lampshade 230.

Moreover, the lampshade 230 in the present embodiment includes a plurality of phosphors 236 scattered within the hollow casing 234, and a user is able to select the required light source 220 disposed in the hollow casing 234. The characteristics of the light may be adjusted by the phosphors 236. For example, blue light may be excited to white light through the phosphors 236, and yet the color, the color temperature, and the characteristics adjustments of the emitted light are not limited to the above.

FIG. 4 is a schematic view of another illumination module in accordance to another embodiment of the present invention. Referring to FIG. 4, the difference between the illumination module 200′ in FIG. 4 and the illumination module 200 in FIG. 3 is mainly that the lampshade 230 in the illumination module 200 in FIG. 3 includes the phosphors 236 scattered within the hollow casing 234, while the lampshade 200′ in FIG. 4 includes a plurality of diffusion particles 238 scattered within the hollow casing 234′. In FIG. 4, the light source 220 may be, but not limited to, a fluorescent light. The light emitted from the light source scatters to different angles through the diffusion particles 238 in the hollow casing 234′ for a better uniformity in light emission.

To sum up the above, the design of the lampshade and the illumination module of the present invention is a hollow casing formed by the plurality of plate structures which are connected to one another. By means of such structures, the light emitted from the light source disposed within the lampshade is able to emit to outside uniformly via the refraction or scattering by means of the plate structures of the lampshade. Additionally, when the phosphors or the diffusion particles are scattered within the lampshade, the characteristics of the light may be adjusted by the phosphors or the uniformity of the light may be enhanced by the diffusion particles in the lampshade and illumination module of the present invention.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A lampshade comprising:
a plurality of plate structures, wherein the plate structures are connected to one another to form a hollow casing having an opening.

2. The lampshade of claim 1, wherein the hollow casing is substantially dome-shaped.

3. The lampshade of claim 1 further comprising a plurality of phosphors scattered in the hollow casing.

4. The lampshade of claim 1 further comprising a plurality of diffusion particles scattered in the hollow casing.

5. An illumination module comprising:
a base plate;
a light source disposed on the base plate; and
a lampshade covered on the base plate, wherein the light source is sited between the base plate and the lampshade, and wherein the lampshade comprises a plurality of plate structures connected to one another to form a hollow casing having an opening.

6. The illumination module of claim 5, wherein the light source comprises a light emitting diode (LED) light, a fluorescent light, a ultraviolet light, or an X-ray light.

7. The illumination module of claim 6, wherein the LED light comprises a chip on board (COB) LED light or a surface-mount technology (SMT) LED light.

8. The illumination of claim 5, wherein the hollow casing is substantially dome-shaped.

9. The illumination of claim 5, wherein the lampshade comprises a plurality of phosphors scattered in the hollow casing.

10. The illumination of claim 5, wherein the lampshade comprises a plurality of diffusion particles scattered in the hollow casing.
